(19) United States
(12) Patent Application Publication
(10) Pub. No.: US 2010/0002664 A1
(43) Pub. Date: Jan. 7, 2010

(54) METHOD AND APPARATUS FOR AVOIDING A COLLISION BETWEEN A SCHEDULING REQUEST AND A PERIODIC RANK INDICATOR REPORT OR A PERIODIC CHANNEL QUALITY INDICATOR/PRECODING MATRIX INDICATOR REPORT

(75) Inventors: Kyle Jung-Lin Pan, Smithtown, NY (US); Donald M. Grieco, Manhasset, NY (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/490,504

(22) Filed: Jun. 24, 2009

Related U.S. Application Data
(60) Provisional application No. 61/077,799, filed on Jul. 2, 2008.

(51) Int. Cl. H04W 72/00

(52) U.S. Cl. 370/338

(57) ABSTRACT

A method and apparatus are described for avoiding a collision between a scheduling request (SR) and a periodic rank indicator (RI) report or a periodic channel quality indicator (CQI)/precoding matrix indicator (PMI) report.

### CROSS REFERENCE TO RELATED APPLICATIONS

This application claims the benefit of U.S. Provisional Application No. 61/077,799 filed Jul. 2, 2008, which is incorporated by reference as if fully set forth.

### FIELD OF INVENTION

This application is related to wireless communications.

### BACKGROUND

For the third generation partnership project (3GPP), a long term evolution (LTE) scheduling request (SR) and periodic rank information (RI) or channel quality indicator (CQI)/precoding matrix indicator (PMI) are transmitted. Collisions occur when an SR is transmitted at the same time, (e.g., in the same subframe), as when a periodic RI, CQI or PMI report is transmitted. A method and apparatus for avoiding such collisions do not currently exist.

### Scheduling Request (SR)

For 3GPP LTE, the SR is for requesting uplink synchronization channel (UL-SCH) resources. If an SR has been triggered, a wireless transmit/receive unit (WTRU) performs the following for each transmission timing interval (TTI), until UL-SCH resources are granted:

1) If no UL-SCH resources are available in this TTI and if a physical uplink control channel (PUCCH) is configured for the WTRU to send an SR in this TTI, the WTRU instructs the physical layer to signal the SR on the PUCCH.

2) If no UL-SCH resources are available in this TTI and if no PUCCH for an SR is configured for the WTRU to send an SR in any TTI, a random access procedure is initiated. Thus, a triggered SR is pending and is repeated until UL-SCH resources are granted.

### Periodically Reporting RI or CQI/PMI

Alternatively, CQI, PMI and RI reports may be transmitted periodically using a PUCCH. A WTRU is semi-statically configured by higher layers to periodically feed back CQI, also possibly PMI, and corresponding RI on the PUCCH using these a wideband reporting mode and a WTRU selected subband feedback (Best-M) mode.

FIG. 1 shows a table of CQI and PMI types for PUCCH reporting modes. Because of the limited number of bits that can be sent on the PUCCH, multiple reports are required as a function of the system bandwidth. The entire bandwidth may be partitioned into several partitions, (i.e., bandwidth parts). Each partition or bandwidth part may be further divided into several smaller segments, (i.e., subbands). In the subframe where CQI for the selected subbands is reported, the WTRU may select the preferred subband, (or the best subband), within the set of subbands in each of the J bandwidth parts, where J ranges from 1 to 4, conditioned on the last reported wideband PMI and RI. A wideband CQI is a single CQI representing the channel quality of the entire bandwidth. A subband CQI is a CQI representing the channel quality of the corresponding selected subband.

Four CQI/PMI and RI reporting types with distinct periods and offsets are supported for each PUCCH reporting mode:

1) Type 1 report supports CQI feedback for the WTRU selected subbands;

2) Type 2 report supports wideband CQI and PMI feedback;

3) Type 3 report supports RI feedback; and

4) Type 4 report supports wideband CQI.

In the case where RI and wideband CQI/PMI reporting are configured, an RI and wideband CQI/PMI are not reported in the same subframe (reporting instance). The reporting interval of the RI reporting is an integer multiple of wideband CQI/PMI period. The same or different offsets between RI and wideband CQI/PMI reporting instances can be configured. Both the reporting interval and offset are configured by higher layers. In case of collision of RI and wideband CQI/PMI the wideband CQI/PMI is dropped.

In the case where RI and both wideband CQI/PMI and subband CQI reporting are configured, the same set of CQI reporting instances, with period P, are used for both wideband CQI/PMI and subband CQI reports. The wideband CQI/PMI report has period H*P, and is reported on the set of reporting instances indexed by {0, H, 2H, . . . }. The integer H is defined as H=J*K+1, where J is the number of bandwidth parts. Between every two consecutive wideband CQI/PMI reports, the remaining J*K reporting instances are used in sequence for subband CQI reports on K full cycles of bandwidth parts.

The reporting interval of RI is M times the wideband CQI/PMI period, and RI is reported on the same PUCCH cyclic shift resource as both the wideband CQI/PMI and subband CQI reports. The offset (in subframes) between the RI and wideband CQI/PMI is denoted as O. In case of a collision between RI and wideband CQI/PMI or subband CQI, the wideband CQI/PMI or subband CQI is dropped. The parameters P, K, M, O are configured by higher layers, such as via a radio resource control (RRC) message, in a semi-static manner.

FIG. 2 shows how RI is transmitted in a subframe, how wideband (WB) CQI or PMI is transmitted and how frequency selective (FS) CQI is transmitted in subframes. As shown in FIG. 2, RI is transmitted in subframe 0, 16, and so on according to the periodicity that is configured. WB, (e.g., WB CQI/PMI), is transmitted in subframe 1, 9, 17, and so on according to periodicity that is configured. FS, (e.g., FS CQI), is transmitted in subframes 3, 5, 7 following WB in subframe 1, and in subframes 11, 13, 15 following WB in subframe 9, and so on. The first and second rows of subframes are for illustration purposes only. They (RI, WB, FS) are actually transmitted in subframes, (in the same single row), according to their subframe number for transmission as described above.

A method and apparatus are desired for avoiding a collision by between the SR and periodic PUCCH reports in case both the SR and the periodic RI or CQI/PMI report occur in the same subframe.

### SUMMARY

A method and apparatus are described for avoiding a collision between an SR and a periodic RI report or a periodic CQI/PMI report.

### BRIEF DESCRIPTION OF THE DRAWINGS

A more detailed understanding may be had from the following description, given by way of example in conjunction with the accompanying drawings wherein:

FIG. 1 shows a table of CQI and PMI types for PUCCH reporting modes;

FIG. 2 shows how RI is transmitted in a subframe, how WB CQI or PMI is transmitted and how FS CQI is transmitted in subframes;

FIG. 3 shows a wireless communication system including a WTRU and an evolved Node-B (eNodeB); and

FIG. 4 shows a table of supported PUCCH formats.

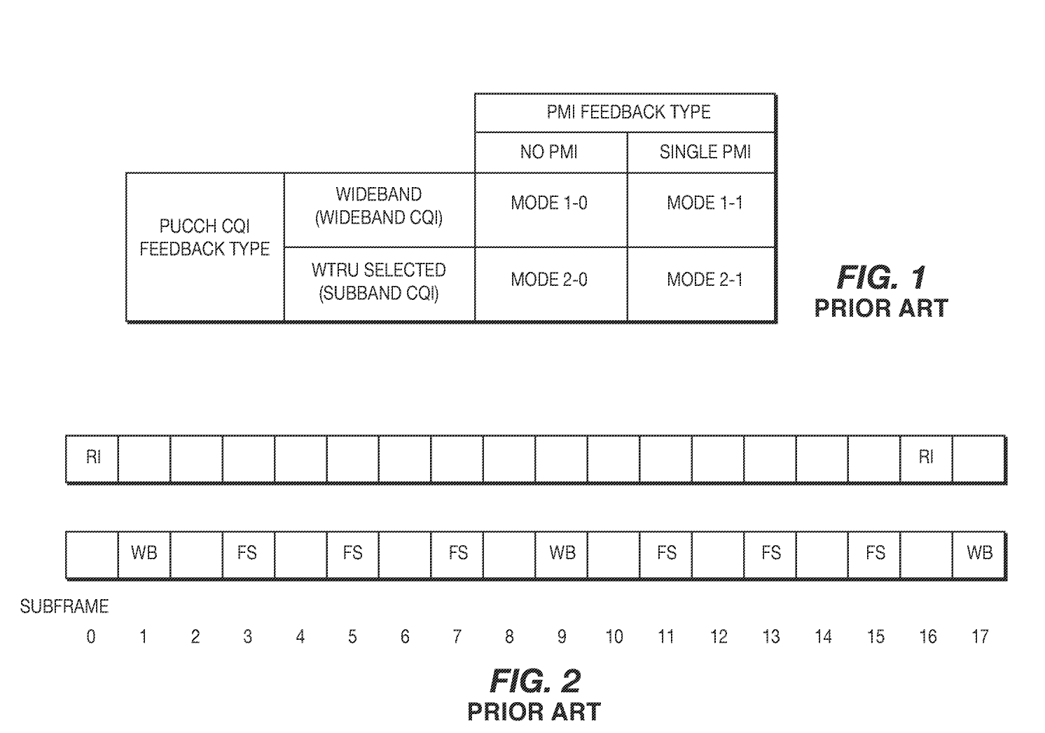

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “evolved Node-B (eNodeB)” includes but is not limited to a base station, a site controller, an access point (AP), or any other type of interfacing device capable of operating in a wireless environment.

Several methods are described for transmitting an SR and the periodic PUCCH reports when both the SR and periodic PUCCH reports occur in the same subframe.

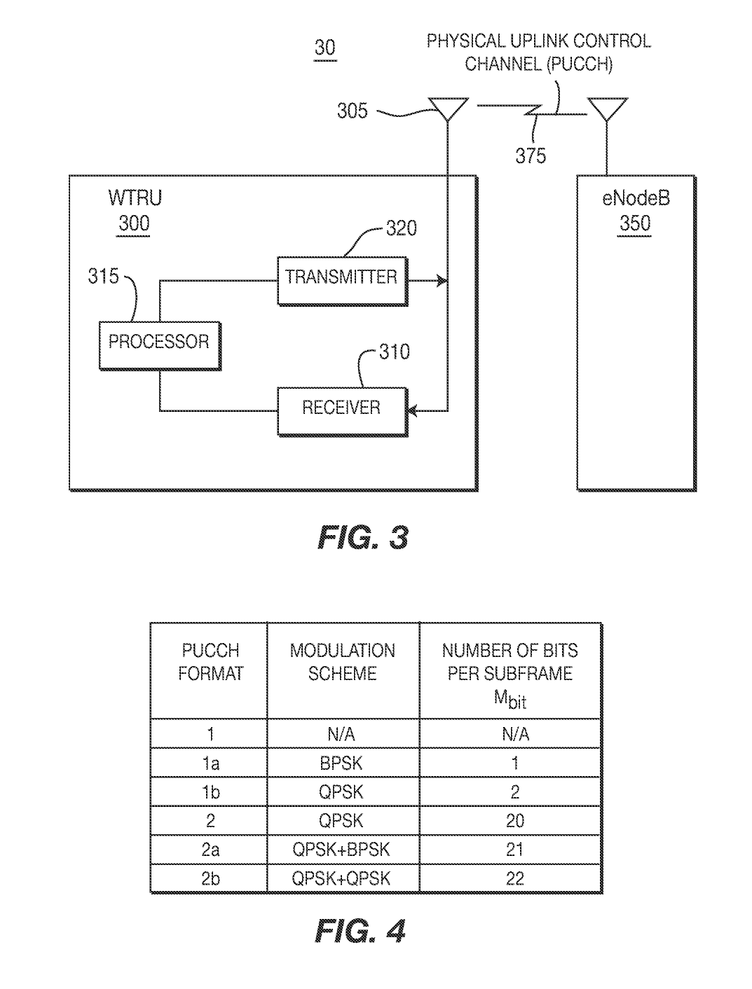

FIG. 3 shows a wireless communication system 30 including a WTRU 300 and an evolved Node-B (eNodeB) 350. The WTRU 300 includes an antenna 305, a receiver 310, a processor 315 and a transmitter 320. The WTRU 300 communicates with the eNodeB 350 via a PUCCH 375. The transmitter 320 is configured to transmit at least one of an SR and a periodic RI report or a periodic CQI/PMI report.

### Avoiding a Collision Between an SR and a Periodic RI Report

When there is an intention to transmit both an SR and RI in the same subframe, the WTRU 300 may transmit the periodic RI on its assigned RI PUCCH resource for a negative SR transmission and transmit the periodic RI on its assigned SR PUCCH resource for a positive SR transmission. SR PUCCH resources are resources that are configured for SR transmission. Such a configuration may be performed via RRC signaling. A positive SR transmission indicates that there is an SR to be transmitted, and a negative SR transmission indicates that there is no SR to be transmitted.

When only a periodic RI report or an SR is transmitted, the WTRU 300 may use PUCCH format 1a or 1b for the RI resource, and PUCCH format 1 for the SR resource. Since a negative SR transmission indicates that there is no SR to send, the RI is transmitted as normal. The PUCCH formats are provided in the table of FIG. 4.

The PUCCH format 1 is mainly used to carry an SR. The PUCCH Format 1 uses energy to indicate whether the information is present or not. For example, if there is an SR, then a signal with energy is sent. If there is no SR, than no signal (i.e., no energy) is sent. A receiver basically detects the signal (either present or not present) based on its energy level. Therefore, there is no modulation scheme for format 1, nor are any bits carried. The PUCCH formats 1a and 1b are used to carry an ACK/NACK for HARQ. The PUCCH format 1a is used for one codeword, (i.e., one transport block). Thus, binary phase shift keying (BPSK) (1 bit) is used. PUCCH format 1b is used for two codewords, (i.e., two transport blocks). Thus, quadrature phase shift keying (QPSK) (2 bits). Format 2 is used to carry CQI/PMI or RI. Format 2a and 2b are used to carry CQI/PMI or RI with ACK/NACK for 1 bit or 2 bits, respectively.

Delay Transmission of SR and Report periodic RI or CQI/PMI

When it is intended that both an SR and either a periodic RI or CQI/PMI report are transmitted in the same subframe, the WTRU 300 may transmit the RI or CQI/PMI report and delay the SR. The SR that was configured to be transmitted on the PUCCH is delayed and transmitted on the next configured opportunity. Since the SR may be repeated frequently, the impact for delaying SR may be minimal. In this case, the eNodeB obtains the complete periodic PUCCH CQI/PMI/RI report without any delay.

### Transmit SR and Delay Transmission of a Periodic RI Report or a CQI/PMI Report

When it is intended to transmit both an SR and a periodic RI or CQI/PMI report in the same subframe, the WTRU 300 may transmit the SR and delay either the RI or CQI/PMI report. The SR that was configured to be transmitted on the PUCCH is transmitted, and the periodic RI or CQI/PMI report is delayed and transmitted on the next reporting opportunity. Regardless of the importance of the PUCCH report, the PUCCH report is delayed and transmitted on the next reporting opportunity in which the original scheduled PUCCH report is kept, delayed and transmitted in the following reporting opportunity. In this case, the eNodeB 350 obtains the complete periodic PUCCH CQI/PMI/RI report with some delay.

The importance of the PUCCH report is considered when delaying or discarding the transmission. More importantly, the PUCCH report is kept with delayed transmission while the less important PUCCH report is discarded. The PUCCH report is delayed and transmitted on the next reporting opportunity in which the original scheduled PUCCH report is discarded, if the original scheduled PUCCH report is less important. In this case, the eNodeB 350 obtains the incomplete periodic PUCCH CQI/PMI/RI report with no delay. The importance of the PUCCH report may be a design parameter. For example, an RI may be considered more important than PMI and CQI, if the PMI and CQI are based on RI. A wideband PMI may be considered more important than a frequency selective CQI, if the frequency selective CQI is based on the wideband PMI.

The methods discussed previously may be combined. For example, one of the previous methods is to transmit the RI report or the CQI/PMI report, and delay the SR. Another method is to transmit the SR and delay the RI report or the CQI/PMI report. However, the SR and the RI report can be transmitted at the same time, and the CQI/PMI report can be delayed. Thus, the RI report does not have to be delayed in all cases.

Multiplex SR with Periodic RI Re-ort Transmission and Handle SR and Periodic CQI/PMI Report Properly

When it is intended to transmit both an SR and a periodic RI report in the same subframe, the WTRU 300 may transmit the periodic RI report on its assigned RI PUCCH resource for a negative SR transmission, and transmit the periodic RI report on its assigned SR PUCCH resource for a positive SR transmission. In the case of no SR, only the periodic RI report is transmitted. When the periodic RI report and the SR are transmitted at the same time, they are multiplexed using the SR resources.

When it is intended to have both an SR or a periodic CQI/PMI report to be transmitted in the same subframe, the WTRU 300 may transmit the periodic CQI/PMI report and delay the SR. The periodic CQI/PMI report is configured by the eNodeB 350, and the SR is triggered by the WTRU 300. If they were to be transmitted in the same subframe, there would be a collision. In order to avoid such a collision, the SR that was configured to be transmitted on the PUCCH is delayed, and transmitted on the next configured opportunity.

When both an SR and a periodic CQI/PMI report are transmitted in the same subframe, the WTRU 300 may transmit the SR and delay the periodic CQI/PMI report. The SR that was configured to be transmitted on the PUCCH is transmitted, and the periodic CQI/PMI report is either delayed or discarded depending on the importance of the periodic CQI/PMI report.

The processor 315 in the WTRU 300 is configured to trigger the transmission of an SR and the transmission of a periodic RI report or a periodic CQI/PMI report. The transmitter 320 in the WTRU 300 is configured to transmit the SR, wherein the processor 315 controls the transmitter 320 such that the transmitter 320 does not transmit the SR at the same time as the periodic RI report or the periodic CQI/PMI report.

The transmitter 320 may transmit the SR in a configured opportunity that occurs after the periodic RI report or the CQI/PMI report is transmitted.

The transmitter 320 may transmit the periodic RI report or the CQI/PMI report in a configured opportunity that occurs after the SR is transmitted.

The transmitter 320 may also be configured to transmit a periodic RI report on an assigned RI PUCCH resource for a negative SR transmission, and transmit the periodic RI report on an assigned SR PUCCH resource for a positive SR transmission. A BPSK or QPSK modulation scheme may be used for the RI PUCCH resource.

The processor 315 may be configured to trigger the transmission of an SR, a periodic RI report and a periodic CQI/PMI report. The transmitter 320 may be configured to transmit the SR, the periodic RI report and the CQI/PMI report, wherein the processor 315 controls the transmitter 320 such that the transmitter 320 transmits the SR and the periodic RI report at the same time, and transmits the periodic CQI/PMI report after transmitting the SR and the periodic RI report.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth®p module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method of avoiding a collision between a scheduling request (SR) and a periodic rank indicator (RI) report or a periodic channel quality indicator (CQI)/precoding matrix indicator (PMI) report, the method comprising:
transmitting the periodic RI report or the periodic CQI/PMI report; and
transmitting the SR after transmitting the periodic RI report or the periodic CQI/PMI report.

2. A method of avoiding a collision between a scheduling request (SR) and a periodic rank indicator (RI) report or a periodic channel quality indicator (CQI)/precoding matrix indicator (PMI) report, the method comprising:
transmitting the SR; and
transmitting the periodic RI report or the periodic CQI/PMI report after transmitting the SR.

3. A method of avoiding a collision between a scheduling request (SR) and a periodic channel quality indicator (CQI)/precoding matrix indicator (PMI) report, the method comprising:
transmitting the SR and a periodic rank indicator (RI) report at the same time; and
transmitting the periodic CQI/PMI report after transmitting the SR and the periodic RI report.

4. A method of avoiding a collision between a scheduling request (SR) and a periodic rank indicator (RI) report, the method comprising:
transmitting the periodic RI report on an assigned RI physical uplink control channel (PUCCH) resource for a negative SR transmission; and
transmitting the periodic RI report on an assigned SR PUCCH resource for a positive SR transmission.

5. The method of claim 4 wherein a binary phase shift keying (BPSK) modulation scheme is used for the RI PUCCH resource.

6. The method of claim 4 wherein a quadrature phase shift keying (QPSK) modulation scheme is used for the RI PUCCH resource.

7. A wireless transmit/receive unit (WTRU) comprising:
a processor configured to trigger the transmission of a scheduling request (SR) and the transmission of a periodic rank indicator (RI) report or a periodic channel quality indicator (CQI)/precoding matrix indicator (PMI) report; and
a transmitter configured to transmit the SR and the periodic RI report or CQI/PMI report, wherein the processor controls the transmitter such that the transmitter does not transmit the SR at the same time as the periodic RI report or the periodic CQI/PMI report.

8. The WTRU of claim 7 wherein the transmitter transmits the SR in a configured opportunity that occurs after the periodic RI report or the CQI/PMI report is transmitted.

9. The WTRU of claim 7 wherein the transmitter transmits the periodic RI report or the CQI/PMI report in a configured opportunity that occurs after the SR is transmitted.

10. A wireless transmit/receive unit (WTRU) comprising:
a processor configured to trigger the transmission of a scheduling request (SR), a periodic rank indicator (RI) report and a periodic channel quality indicator (CQI)/precoding matrix indicator (PMI) report; and
a transmitter configured to transmit the SR, the periodic RI report and the CQI/PMI report, wherein the processor controls the transmitter such that the transmitter transmits the SR and the periodic RI report at the same time, and transmits the periodic CQI/PMI report after transmitting the SR and the periodic RI report.

11. A wireless transmit/receive unit (WTRU) comprising:
a processor; and
a transmitter configured to transmit a periodic rank indicator (RI) report on an assigned RI physical uplink control channel (PUCCH) resource for a negative SR transmission, and transmit the periodic RI report on an assigned scheduling request (SR) PUCCH resource for a positive SR transmission.

12. The WTRU of claim 11 wherein a binary phase shift keying (BPSK) modulation scheme is used for the RI PUCCH resource.

13. The WTRU of claim 11 wherein a quadrature phase shift keying (QPSK) modulation scheme is used for the RI PUCCH resource.
